(19) United States
(12) Patent Application Publication
(10) Pub. No.: US 2008/0067349 A1
(43) Pub. Date: Mar. 20, 2008

(54) Multi-channel time-of-flight mass spectrometer

(75) Inventors: Eugene Moskovets, Malden, MA (US); Vladimir M. Doroshenko, Ellicott City, MD (US)

Correspondence Address: OBLON, SPIVAK, MCCLELLAND MAIER & NEUSTADT, P.C., 1940 DUKE STREET, ALEXANDRIA, VA, 22314, US

(73) Assignee: Science & Engineering Services, Inc., Columbia, MD (US)

(21) Appl. No.: 11/441,177

(22) Filed: May 26, 2006

(51) Int. Cl. H01J 49/40

(52) U.S. Cl. 250/287

(57) ABSTRACT

A system and method for mass analysis of ions. The system includes an orthogonal acceleration time-of-flight mass analyzer having at least two channels configured to receive respective groups of ions from respective ion sources and having a field-free section configured to mass-separate ions during flight time. The groups of ions are directed to different ones of the channels of the mass analyzer for mass analysis of the respective groups of ions, and at least a part of the field-free section is shared between the channels. The method introduces the ions into an orthogonal acceleration time-of-flight mass analyzer, directs groups of ions from respective ones of the two sources into different channels of the mass analyzer, and simultaneously mass-analyzes the groups of ions from the different channels.

### DISCUSSION OF THE BACKGROUND

1. Field of the Invention

The invention relates to the field of analytical chemistry and mass spectrometry. The invention specifically relates to high resolution and high throughput mass spectrometry, and more specifically to hybrid quadrupole/orthogonal extraction time-of-flight mass spectrometry.

2. Background of the Invention

One goal in the post-genomic era is the development of high-throughput methods to study the cell proteome, especially the changes to the cell proteome induced by diseases or environmental conditions. This task includes determining the identities of proteins and their post-translation modifications (PTM) as well as their relative concentrations to distinguish differential expression of proteins. High-resolution mass spectrometry is one element considered for high-throughput proteomics because high-resolution mass spectroscopy can provide an efficient technique for profiling samples with high selectivity, high sensitivity, and over a wide range of PTM. Both 2D gels and multidimensional liquid chromatography (LC) separations have been used in conjunction with MS analysis.

The coupling of reverse phase high-performance liquid chromatography (RP-HPLC) and mass spectrometry (MS) is one of the leading techniques in proteomic research. LC-MS has become a standard and widely-used method for cell proteome characterization. Most proteome characterization methods utilize multiple high resolution LC runs that require increasing the throughput of the LC-MS method. In recent years, high resolution separations using capillary columns combined with nano-electrospray (nano-ESI) or matrix-assisted laser desorption/ionization (MALDI) ion sources were applied for MS analysis of very complex peptide mixtures demonstrating attomole sensitivity and 4-5 orders of linear dynamic range. Protein glycosylation is an issue of proteomic science that affects protein properties and functions. The complexity and diversity of glycosylation complicates the linkage between genetic sequence and mature, active proteins; its study constitutes the field of glycomics. So far, the combined procedures of an affinity capture of glycoproteins followed by LC separation and mass analysis has been demonstrated as an efficient method for characterization of glycosylation process.

LC separation can be coupled to MS on-line or off-line. On-line coupling usually requires a devoted ESI-MS system for the entire time of the LC run. A single run in high-resolution LC systems typically can take more than 1 hour. This long time together with a high cost of high-end mass spectrometers and very large number of consecutive LC runs normally required for one sample characterization limits research lab productivity in the proteomics and glycomics areas.

Multi-column LC systems are widely used to increase sample analysis throughput. There were developments of multi-channel MS instruments but these used only low-resolution mass spectrometer (like ion traps or miniature axial time-of-flight mass spectrometers). Also, there have been attempts to use various devices multiplexing several LC columns to a single (MALDI or ESI) high resolution MS. Multiple LC columns can be coupled via separate ESI sources to a mechanical multiplexing device to spray samples eluting from the LC columns to a single-channel mass spectrometer (e.g., one at a time). Sample carryover between LC/ESI channels and lower sensitivity due to a reduction of system duty cycle are however disadvantages experienced in this approach.

The combination of ESI source with a time-of-flight mass spectrometer has become an efficient tool after the rediscovery in the art of the “orthogonal acceleration” (oa) TOF concept. In a hybrid quadrupole/time-of-flight mass spectrometer (qTOF or QqTOF), ions are selected using a first linear quadrupole operated in a mass filter mode (Q) and, then, selected ions are fragmented in a second RF-only quadrupole (q) before directing them into oaTOF-MS. Such a configuration is usually referred as QqTOF.

The pressure in the RF-only quadrupole is maintained typically at 10-100 mTorr to “cool” the plume of product ions. Usually, argon is added into the second quadrupole unit. In collision-activated dissociation (CAD) experiments, ions acquire the collisional energy when an appropriate voltage is applied between the first and second quadrupoles. The entire mass spectrum is recorded when both quadrupoles are operated in the RF-only mode and the collision energy is kept below 10 eV. Both sensitivity and resolution benefit from the additional collisional focusing in the pressurized collision quadrupole.

One feature of oaTOF with collisional cooling of ESI-produced ions is a decoupling of the ion source from the time-of-flight mass analyzer. An ion beam entering the acceleration region (pulser) of the TOF mass spectrometer is well-focused. The ion focusing due to a transverse space distribution of the ion beam in the pulser region is compensated by combining a two-stage accelerator with a reflectron (or ion mirror) to achieve second or high order focusing of the initial ion spatial distribution. This allows one to obtain high-quality mass spectra with mass resolving power exceeding 10,000 which is uniform across the spectrum. Another advantage of the QqTOF instrument is its ability to record all ions without scanning. This leads to higher accuracy in mass determination, since ions of all masses are measured at the same time. The high mass resolution and the simplicity of the mass calibration provide mass accuracy better than 5 ppm. Further, the QqTOF mass spectrometer has a wide mass range limited only by the RF ion guides.

Despite these advantages, multi-channel MS system interfaced to several LC columns has been utilized in designing small and low-resolution MS systems, like miniature ESI ion trap and MALDI time-of-flight (TOF) MS. These MS systems have not used QqTOF mass spectrometers and have been limited by their low-resolution and not useful for proteomics and glycomics applications where the mass accuracy better than 5-10 ppm is typically required.

Moreover, conventionally the MALDI approach has demonstrated only limited success and low sensitivity (as compared to nano-ESI). Off-line coupling, normally associated with MALDI-MS, in principle, allows coupling a high throughput mass spectrometer with many LC columns. However, this approach has demonstrated only limited success. For example, using one of the most advanced MALDI-MS and a 2 kHz high repetition laser, it has been shown that samples were collected and analyzed from only four LC runs for the time of one LC run.

The following articles relate to a number of sophisticated mass spectroscopy techniques that have been reported in the scientific literature. All of these articles are incorporated herein in entirety by reference:

1. Bogdanov, B.; Smith, R. D., Proteomics by FTICR Mass Spectrometry: Top Down and Bottom Up, Mass Spectrom. Rev., 2005, 24(2), 168-200.

2. Lilley, K. S.; Friedman, D. B., All about DIGE: Quantification Technology for Differential-display 2D-gel Proteomics, Expert Rev. Proteomics, 2004, 1(4), 401-409.

3. Washburn, M. P.; Ulaszek, R. R.; Yates, J. R., III, Reproducibility of Quantitative Proteomic Analyses of Complex Biological Mixtures by Multidimensional Protein Identification Technology, Anal Chem., 2003, 75(19), 5054-5061.

4. Rappsilber, J.; Ryder, U.; Lamond, A. I.; Mann, M., Large-Scale Proteomic Analysis of the Human Spliceosome, Genome Res., 2002, 12, 1231-1245.

5. Ducret, A.; Van Oostveen, I.; Eng, J. K.; Yates, J. R., III; Aebersold, R., High Throughput Protein Characterization by Automated Reverse-phase Chromatography/Electrospray Tandem Mass Spectrometry, Protein Sci., 1998, 7(3), 706-719.

6. Schultz, G. A.; Corso, T. N.; Prosser, S. J.; Zhang, S., A Fully Integrated Monolithic Microchip Electrospray Device for Mass Spectrometry, Anal. Chem., 2000, 72(17),4058-63.

7. Chen, H. S.; Rejtar, T.; Andreev, V.; Moskovets, E.; Karger, B. L., High-speed, High-resolution Monolithic Capillary LC-MALDI MS Using an Off-line Continuous Deposition Interface for Proteomic Analysis. Anal. Chem., 2005, 77, 2323-2331

8. Luo, Q.; Shen, Y. L.; Hixson, K. K.; Zhao, R.; Yang, F.; Moore, R. J.; Mottaz, H. M.; Smith, R. D., Preparation of 20-μm-i.d. Silica-based Monolithic Columns and Their Performance for Proteomics Analyses, Anal Chem., 2005, 77(15), 5028-5035.

9. Zhang, H.; Li, X-J.; Martin, D. B.; Aebersold, R., Identification and Quantification of N-linked Glycoproteins Using Hydrazide Chemistry, Stable Isotope Labeling and Mass Spectrometry, Nature Biotechnology, 2003, 21, 660-666.

10. Bayliss, M. K.; Little, D.; Mallett, D. N.; Plumb, R. S., Parallel Ultra-high Flow Rate Liquid Chromatography with Mass Spectrometric Detection Using a Multiplex Electrospray Source for Direct, Sensitive Determination of Pharmaceuticals in Plasma at Extremely High Throughput, Rapid Commun. Mass. Spectrom., 2000,14(21), 2039-45.

11. Leclercq, L.; Delatour, C.; Hoes, I.; Brunelle, F.; Labrique, X.; Castro-Perez, J., Rapid Use of a Five-channel Multiplexed Electrospray Quadrupole Time-of-flight Hybrid Mass Spectrometer for Metabolite Identification, Commun. Mass Spectrom., 2005, 19, 1611-1618.

12. Misharin, A. S.; Laughlin, B. S.; Vilkov, A.; Takats, Z.; Ouyang, Z.; Cooks, R. G. High Throughput Mass Spectrometry Using Atmospheric Pressure Ionization in a Cylindrical Ion Trap Array, Anal. Chem., 2005, 77, 459-470.

13. Cornish, T. J.; Antoine, M. D.; Ecelberger, S. A.; Demirev, P. A. Arrayed Time-of-flight Mass Spectrometry for Time-critical Detection of Hazardous Agents, Anal. Chem., 2005, 77 (13), 3954-3959.

14. Dodonov, A. F.; Chernushevich, I. V.; Laiko, V. V., in: 12th Int. Mass Spectrom. Conf., Book of Abstracts, Aug. 26-31, 1991, p. 153.

15. Morris, H. R.; Pacton, T.; Dell, A.; Langhorne, J.; Berg, M.; Bordoli, R. S.; Hoyes, J.; Bateman, R. H., High Sensitivity Collisionally-activated Decomposition Tandem Mass Spectrometry on a Novel Quadrupole/Orthogonal-acceleration Time-of-flight Mass Spectrometer, Rapid Commun. Mass Spectrom., 1996, 10, 889-896.

16. Chernushevich, I. V.; Loboda, A. V.; Thomson, B. A., An Introduction to Quadrupole/Time-of-flight Mass Spectrometry, J Mass Spectrom., 2001, 36, 849-865.

17. Krutchinsky, A. N.; Chernushevich, I. V.; Spicer, V. L.; Ens, W.; Standing, K. G., A Collisional Damping Interface for an Electrospray Ionization TOF Mass Spectrometer, J. Am. Soc. Mass Spectrom., 1998, 9, 569-579.

18. Dodonov, A. F.; Kozlovski, V. I.; Soulimenkov, I. V.; Raznikov, V. V.; Loboda, A. V.; Zhen, Z.; Horwarth, T.; Wollnik, H., High-resolution Electrospray Ionization Orthogonal-injection Time-of-flight Mass Spectrometer, Eur. J. Mass Spectrom., 2000, 6, 481-490.

19. Mirgorodskaya, O. A.; Shevchenko, A. A.; Chernushevich, I. V.; Dodonov, A. F.; Miroshnikov, A. I., Electrospray-Ionization Time-of-Flight Mass-Spectrometry in Protein Chemistry, Anal. Chem., 1994, 66, 99-107.

20. Verentchikov, A. N.; Ens, W.; Standing, K. G., Reflecting Time-of-Flight Mass Spectrometer with an Electrospray Ion Source and Orthogonal Extraction, Anal. Chem., 1994, 66, 126-133.

21. Langmuir, R. V., Quadrupole Mass Filter with Means to Generate a Noise Spectrum Exclusive of the Resonant Frequency of the Desired Ions to Deflect Stable Ions, U.S. Pat. No. 3,334,225, Aug. 1, 1967.

22. Doroshenko, V. M.; Cotter, R. J., Advanced Stored Waveform Inverse Fourier Transform Technique for Matrix-Assisted Laser Desorption/Ionization Quadrupole Ion Trap Mass Spectrometer, Rapid Commun. Mass Spectrom., 1996, 10(1) 65-73.

23. Chernushevich, I. V., Duty Cycle Improvement for a Quadrupole-time-of-flight Mass Spectrometer and Its Use for Precursor Ion Scans, Eur. J. Mass Spectrom., 2000, 6(6), 471-479.

24. McIntyre, D. E.; Miller, C. A., Accurate Mass Measurement of Pharmaceutical Products Coupling Capillary Electrophoresis to an API-TOF Using Atmospheric Pressure Photoionization, in: Proc. 53-rd ASMS Conf. Mass Spectrom. Allied Topics, San Antonio, Tex., Jun. 5-9, 2005.

25. Moskovets, E.; Preisler, J.; Chen, H. S.; Rejtar, T.; Andreev, V.; Karger, B. L., High-throughput Axial MALDI-TOF MS Using a 2-kHz Repetition Rate Laser, Anal Chem., 2006, 78(3), 912-919.

26. Loboda, A., Novel Ion Mobility Setup Combined with Collision Cell and Time-of-Flight Mass Spectrometer, J Am. Soc. Mass. Spectrom., 2006, 17(5), 691-699.

27. U.S. Pat. No. 6,580,070.

28. U.S. Pat. Publ. Appl. No. 20040217279.

29. R. Graham Cooks, Wolfgang R. Plass, G. E. Patterson, A. Vilkov and Z. Takats; Ion trap mass spectrometers: designs and potential applications, in: Proceedings of the 49th ASMS Conference on Mass Spectrometry and Allied Topics, Chicago, Ill., May 27-31, 2001.

### SUMMARY OF THE INVENTION

One object of the present invention accomplished in various of the embodiments is to provide a system (and corresponding method) for analyzing ions from multiple sources.

Another object of the present invention accomplished in various of the embodiments is to provide a system (and corresponding method) for directing ions from multiple sources into separate mass analysis channels.

Yet another object of the present invention accomplished in various of the embodiments is to provide a system (and corresponding method) for mass analyzing separately ions from different sources within the same spectrometer.

Various of these and other objects are provided for in certain ones of the embodiments of the present invention.

In one embodiment of the present invention, there is provided a system for mass analysis of ions. The system includes an orthogonal acceleration time-of-flight mass analyzer having at least two channels configured to receive respective groups of ions from respective ion sources and having a field-free section configured to mass-separate ions during flight time. The groups of ions are directed to different ones of the channels of the mass analyzer for mass analysis of the respective groups of ions, and at least a part of the field-free section is shared between the channels.

In one embodiment of the present invention, there is provided a method for mass analysis of ions. The method introduces the ions into an orthogonal acceleration time-of-flight mass analyzer, directs groups of ions from respective ones of the two sources into different channels of the mass analyzer, and mass-analyzes the groups of ions from the different channels simultaneously.

In one embodiment of the present invention, there is provided a system for mass analysis of ions. The system includes means for introducing the ions from at least two sources of ions into an orthogonal acceleration time-of-flight mass analyzer. The system includes means for directing groups of ions from respective ones of the two sources to different channels of the mass analyzer. The system includes means for mass-analyzing the groups of ions from the different channels simultaneously.

It is to be understood that both the foregoing general description of the invention and the following detailed description are exemplary, but are not restrictive of the invention.

### BRIEF DESCRIPTION OF THE DRAWINGS

A more complete appreciation of the present invention and many attendant advantages thereof will be readily obtained as the same becomes better understood by reference to the following detailed description when considered in connection with the accompanying drawings, wherein:

FIGS. 1A-B are schematic views of a multi-channel QTOF mass spectrometer having a planar geometry according to one embodiment of the present invention;

FIGS. 2A-B are schematic views of a multi-channel QTOF mass spectrometer having an axial geometry according to one embodiment of the present invention;

FIGS. 3A-C show details of ion isolation, fragmentation, and ejection into the pulser region of one embodiment of the present invention;

FIG. 4 shows a configuration of the vacuum system for multi-channel QTOF-MS according to one embodiment of the present invention;

FIG. 5 shows a configured for simultaneous space focusing of ions in all MS channels according to one embodiment of the present invention; and

FIG. 6 is a flowchart illustrating a method according to one embodiment of the present invention.

### DETAILED DESCRIPTION OF THE INVENTION

There is a need for high throughput LC-MS analysis using high-resolution MS instruments. In the present invention, multiple LC columns are interfaced to a multi-channel MS. According to one embodiment of the present invention, a QqTOF(or QTOF) MS instrument provides the multi-channel MS. QTOF in this application offers high mass accuracy (2-3 ppm), reasonable size, and cost efficiency due to a high degree of sharing major subsystems between all channels.

QqTOF-MS offers the highest mass accuracy comparable to that of FTICR-MS (2-3 ppm), high throughput (due to pulsing ions into oaTOF with high frequency up to 10 kHz), reasonable size (desktop QqTOF systems are commercially available) and cost efficiency. In one embodiment of the present invention, subsystems of QqTOF-MS are shared between channels to reduce cost and complexity even more.

In another embodiment of the present invention, a multi-channel ESI-QqTOF mass spectrometer having many common channel parts/subsystems (i.e., shared between the channels) provides a MS system with reasonable size without compromising on instrument performance including mass resolution, mass accuracy, and dynamic range (including channel cross-talk). Sample throughput in these units will be proportional to the number of the channels. In one embodiment of the present invention, each channel operation can be completely independent of other channels, thus making the MS system operation the same as if a single-channel QqTOF-MS was used.

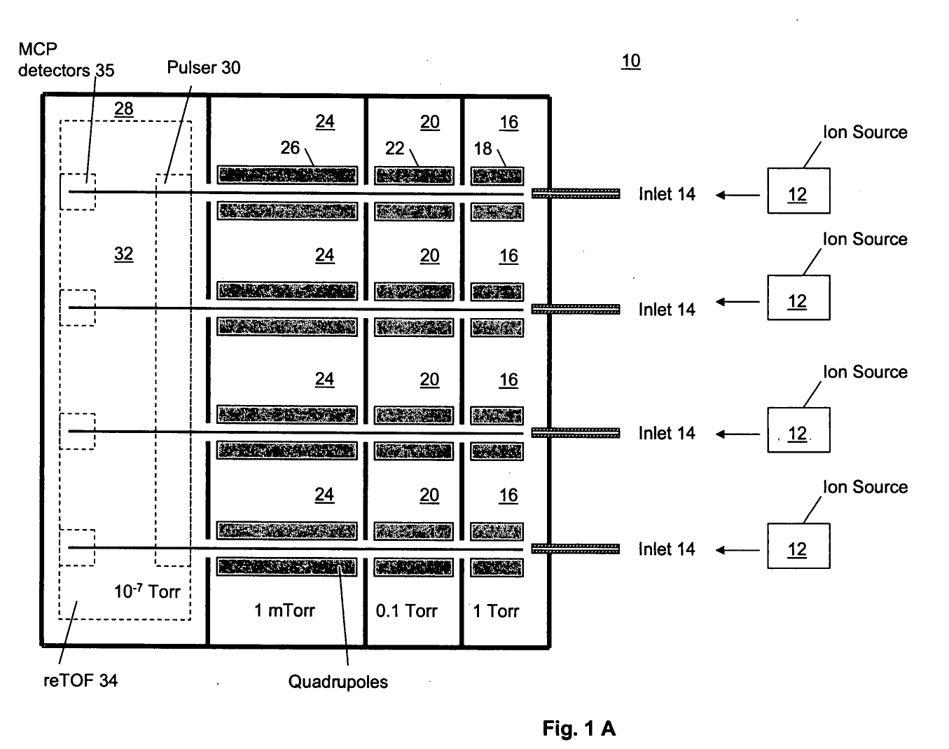

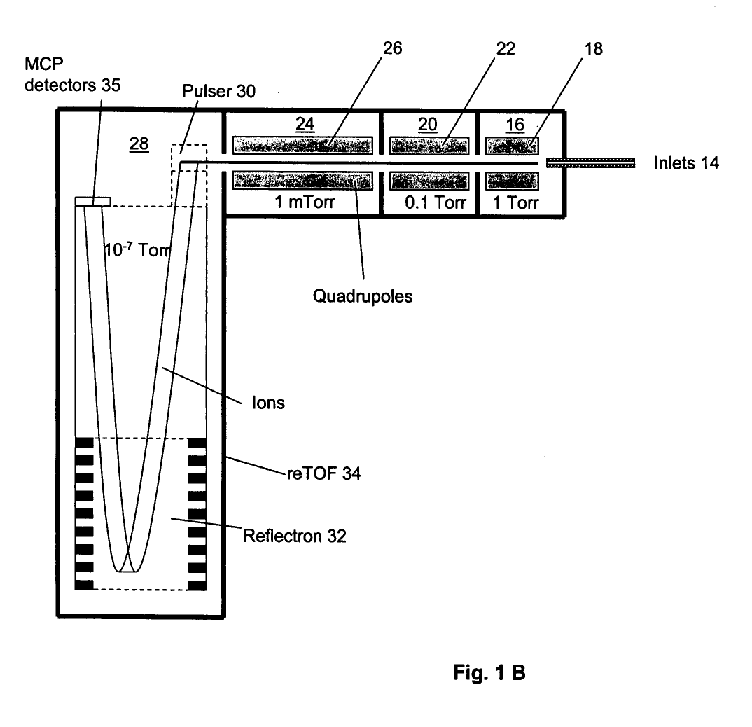

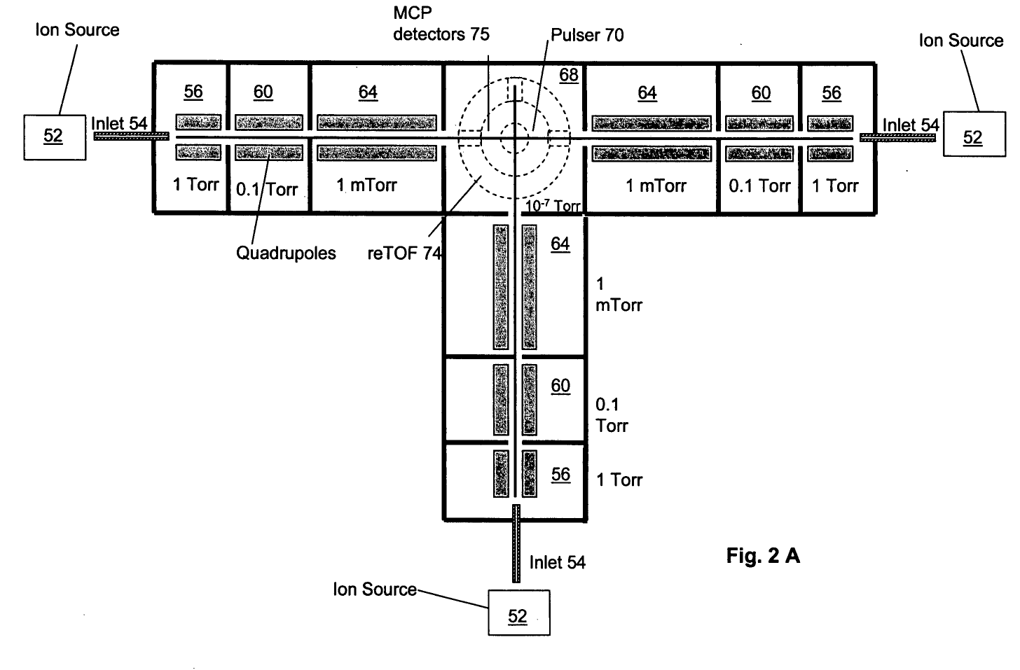

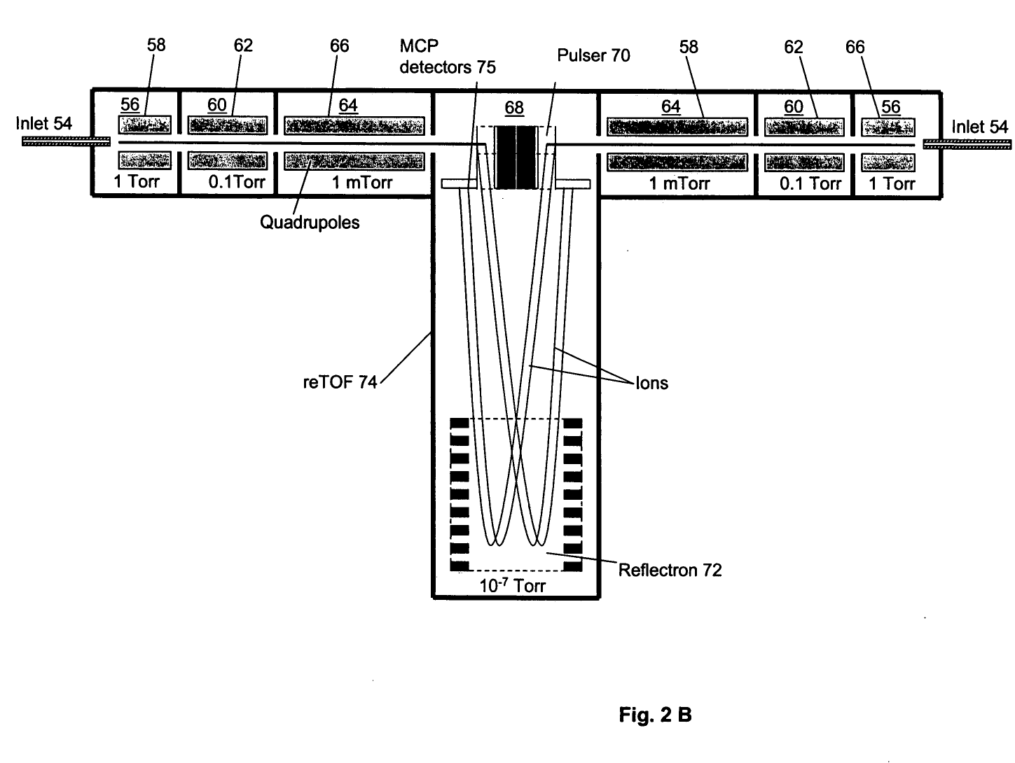

Referring now to the drawings, wherein like reference numerals designate identical, or corresponding parts throughout the several views, and more particularly to FIGS. 1A and 1B, FIG. 1A is a schematic top view of the multi-channel QTOF mass spectrometer 10 of the present invention showing in one embodiment a planar geometry. FIG. 1B is a side view of the unit in FIG. 1A. Only four channels are shown for simplicity. FIG. 2A is a schematic top view of a multi-channel QTOF mass spectrometer 50 of the present invention showing in one embodiment an axial geometry. FIG. 2B is a side view of the unit in FIG. 2A. Only three channels are shown for simplicity. The number of channels shown in FIGS. 1A-2B can be increased or decreased as necessary.

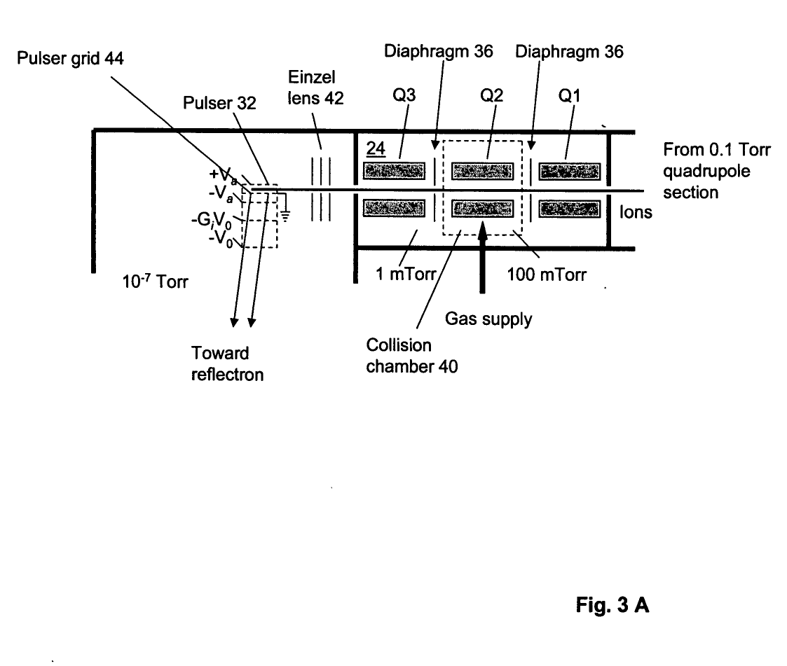

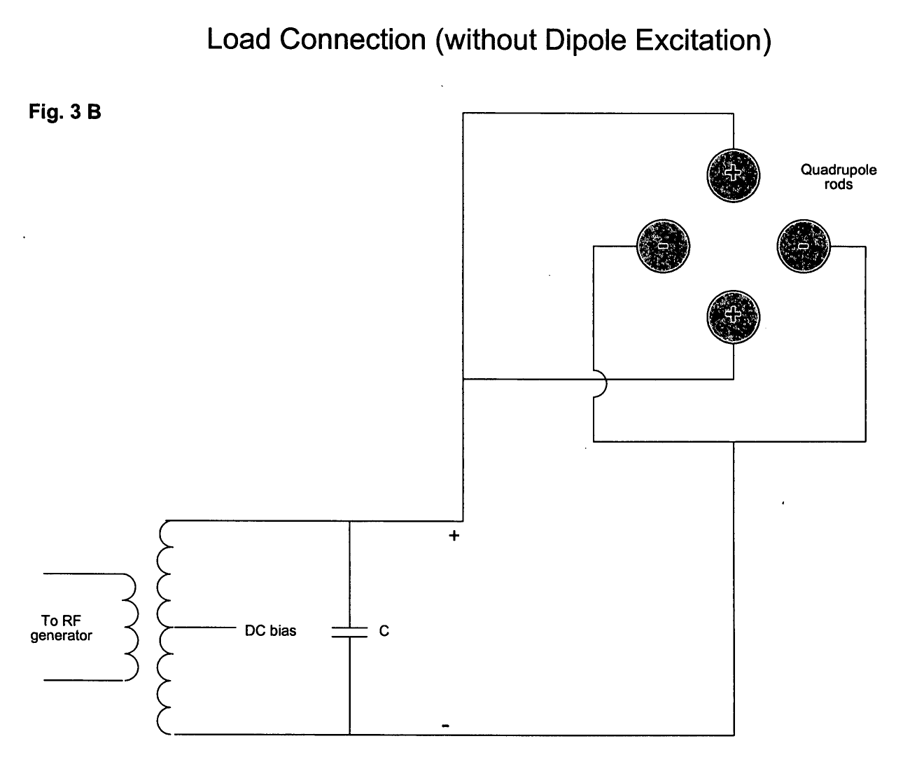

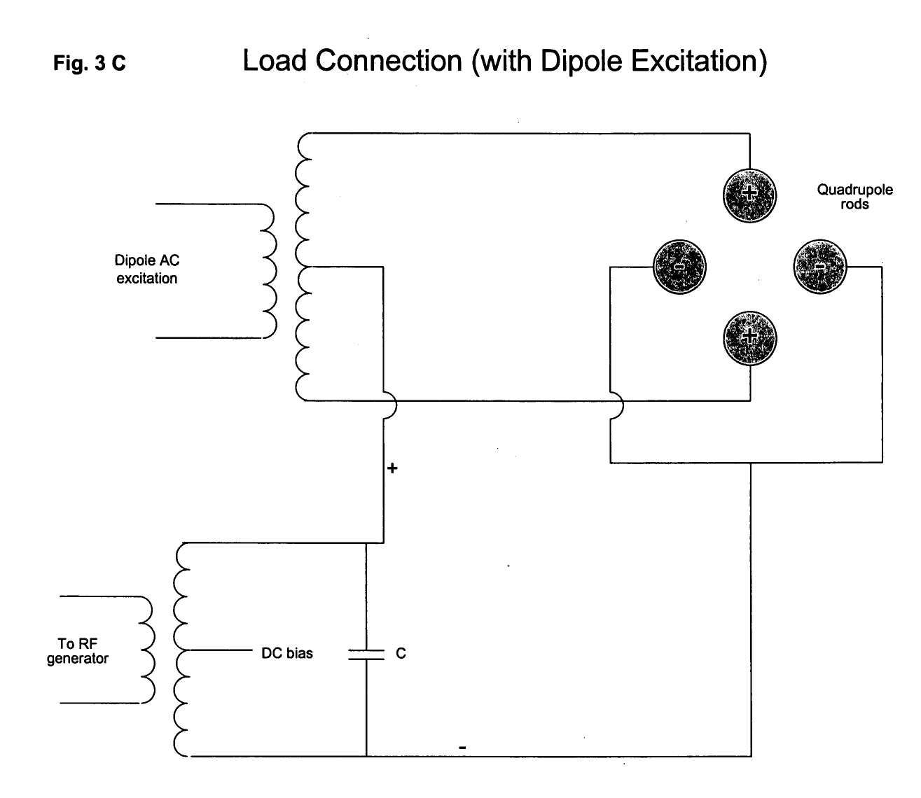

While the configurations of the multi-channel QqTOF-MS are shown in FIGS. 1 and 2 for planar and axial design geometries respectively, there are no substantial differences between these two geometries in terms of the number of subsystems shared between the MS channels. However, there are differences in the orthogonal accelerator (or pulser) and oa-reTOF designs. The planar geometry shown in FIG. 1A can provide a higher number of MS channels, since the axial geometry has limited space for placing micro-channel plate (MCP) detector around a reTOF analyzer. On the other hand, the axial geometry may provide for better spatial integration and a simpler design since a “round” reflectron and main (10⁻⁷ Torr) vacuum chamber (although a square one is shown in FIG. 2A) can be used. Pressurized collisional chambers required for collisional induced dissociation (CID) and MS/MS, not shown for simplicity in FIGS. 1 and 2 but shown separately in FIG. 3 (one channel is shown for simplicity), can be used in one embodiment of the present invention.

Briefly illustration, in operation of the MS systems 10, 50 of the present invention, ions are provided from separate ion source 12, 52 such as for exampled separate ESI ion sources or any other sources like MALDI, atmospheric (AP) MALDI, AP chemical ionization (APCI), or AP photoionization (APPI). The ions enter the MS systems 10, 50 by inlets 14, 54 such as for example separate heated capillaries of 0.5-1 mm diameter. The ions enter into the first vacuum region 16, 56 (e.g., a 1 Torr vacuum region) in which a first set of quadrupoles 18, 58 operating for example at the 1 Torr pressure focus and direct ions further into a second vacuum region 20, 60 (e.g, a 0.1 Torr vacuum region). While not shown in FIGS. 1A-2B, the second vacuum region can include an ion separator which separates ion based on ion mobility. An electrostatic lens/skimmer can also be used for ion introduction/focusing into the first and second vacuum regions.

After collisional cooling in the quadrupoles in the second vacuum region 20, 60, a second set of quadrupoles 22, 62 operating for example at the 1 Torr pressure in the second vacuum regions 20, 60 can focus and direct ions further into a third vacuum region 24, 64 (e.g, a 1 mTorr vacuum region). The ions upon being transferred into the third vacuum region 22, 62 are acted on by a third set of quadrupoles 26, 66. Ions in the third vacuum region 24, 64 are further acted on by conductance limits/diaphragms (shown in FIG. 3A) floating at small DC potentials to further direct the ions into the main vacuum region 28, 68 where a pulser device 30, 70 is located. Ions leaving the pulser device 30, 70 enter the reflectron 32, 72 of the reTOF analyzer 34, 74. The region between the pulser device 32, 72 and the entrance to the reflectron 34, 74 is considered a field-free section in which the ions mass-separate during flight time. Moreover, ions in the first, second, and third vacuum regions can be directed from the inlets 14, 54 to the pulser device 30, 70 by small DC electric potentials (e.g., 2-10 V) applied between the quadrupoles and/or the diaphragms 36 (See FIG. 3A). In the reTOF mass analyzer 32, 72, ions transit the orthogonal reflectron of the reTOF analyzer 34, 74 for example by making one turn before reaching an ion detector (as illustrated in FIGS. 1B and 2B) or by making multiple turns (i.e., the so called multi-pass reTOF-MS). As shown in FIGS. 1A-2B, in one embodiment of the present invention, there are detectors 35, 75 dedicated to each channel to permit (if needed) simultaneous detection of the ions in each channel.

An ion isolation quadrupole and collisional chamber 40 for ion fragmentation permitting MS/MS spectra analysis can be included in one embodiment of the present invention as shown in FIGS. 3A-C. In one embodiment of the present invention, the quadrupole Q1 in FIG. 3A can be used for ion isolation, Q2 can be used for ion fragmentation, and Q3 can be used for cooling ion fragments. In the shown embodiment in FIG. 3A, the ion guides in the channels are fully separate. However, the same RF voltage could be applied to the quadrupoles. Thus, the RF voltage generator in one embodiment of the present invention can be shared between all quadrupoles in the first, second, and third vacuum regions. To retain this advantage when the ion isolation and/or collisional quadrupole sections are added to obtain MS/MS capability, a transverse broadband excitation (for example, a stored waveform inverse Fourier transfer, or SWIFT, method, as known in the art) can be used for ion isolation instead of quadrupole filters operating in RF/DC mode, in which both RF and DC voltages should be adjusted according to m/z chosen for the isolation. In the case of broadband excitation, the same RF voltage can still be applied to all quadrupoles Q1, Q2, Q3 but the low voltage broadband excitation waveforms applied across the isolation quadrupole rods (Q1 in FIG. 3A) will be specific to each channel. A multi-channel arbitrary waveform generation board (like Model UF.6012, Strategic Test Corporation, Woburn, Mass.) can be used for the multiple waveform generation.

The way to apply both trapping RF and broadband (AC) excitation waveforms to the isolation quadrupole Q1 is shown in FIG. 3C (FIG. 3B shows a connection diagram to apply the RF voltage to other quadrupoles, like Q2 and Q3, where no additional excitation is required). The quadrupole Q2 is typically placed inside an enclosure (chamber) which is connected to the third vacuum region 24, 64 via small conductance limits (typically 1-2 mm diameter). The collision gas (e.g., argon) is supplied into the collision chamber 40 (by a gas supply as depicted in FIG. 3A) to maintain a pressure about 100 mTorr in the region of Q2 to maintain an effective fragmentation via collision with argon molecules. The energy of collisions can be controlled for example by maintaining the voltage difference between the quadrupoles Q1 and Q2 (typically 50-100 V). If small voltage (less then 10 V) is applied between Q1 and Q2 then the ions pass the quadrupole Q2 without fragmentation (resulting in normal MS mode).

After leaving the quadrupole section, the ion beam is focused and slightly steered by ion optical lenses 42 (like the Einzel lens in FIG. 3A) to obtain a collimated beam that is parallel to the pulser entrance grid 44 and that enters the pulser device 32, 72. The pulser entrance slit 46, 86 is normally about 1 mm wide providing a parallel beam to obtain a high mass resolution (typically, more than 10,000). The ion optical lenses 42 can use low voltages (e.g., 10-50 V maximum) for shaping the ion beam and for this reason can be channel-specific (for tuning purposes).

The pulser device 32, 72 can utilize high repetition and fast front edge high voltage pulses to push ions into the orthogonal reflectron (typically 5-10 kHz, typically up to 1 kV amplitude or more). The pulser device 32, 72 can be shared between all channels. Instead of periodic push-out pulses, the pulses in the accelerator can be pseudo-randomly spread in time (i.e., the so called Hadamard oa-reTOF design).

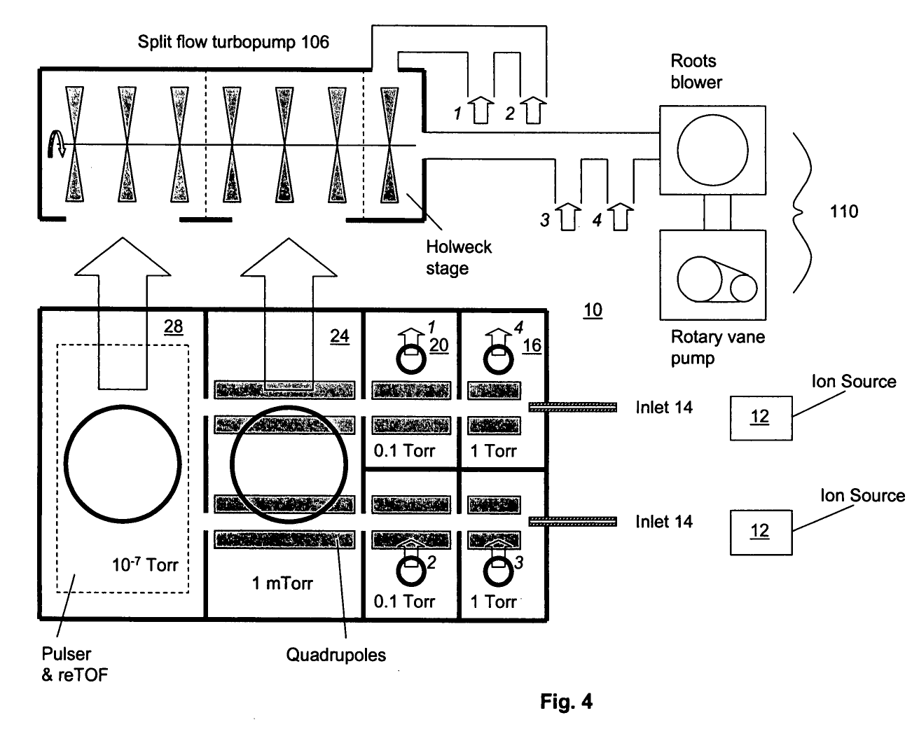

The design of the vacuum system in one embodiment of the present invention serves to minimize cross-talk between the channels and permits a more dynamic range to be achieved. The vacuum system design in one embodiment of the present invention is shown in FIG. 4. A single split flow turbo molecular pump 100 can be used in the multi-channel QqTOF-MS 10, 50. The split flow turbo molecular pump 100 can have as shown three inlets corresponding to inlets for example at vacuum of 10⁻⁷ Torr, 1 mTorr, and 100 mTorr ranges. Separate pumps can also be used in other embodiments of the present invention. Due to significant increase of gas load streaming inside the vacuum system from multiple inlets, the pumping capacity of vacuum pumps reducing pressure from the atmospheric pressure to lower pressures should be appropriately sized to maintain the requisite vacuum level at different vacuum regions.

The first vacuum region 16 in the multi-channel system 10 can be pumped using for example a roots blower/rotary vane pump system 110 (e.g., Model 2033+RSV 301 B by Adixen-Alcatel, France,) offering for example a pumping speed up to 300 m³/hr at 1 Torr pressure). To minimize cross-talk in the high pressure areas where a substantial gas and ion cross flow may take place, the first and second vacuum regions 16 and 20 can be separated into subsections pumped by the same pumps but through separate vacuum hoses (e.g., connecting between ports 1, 2, 3, and 4 as shown in FIG. 4). One purpose of the vacuum connectors is to minimize possible cross talk between the first vacuum region 16 (e.g., the 1-Torr subsections) and the second vacuum region 20 (e.g., the 0.1-Torr subsections). Like in the first vacuum region 16, the gas load in the second vacuum region 20 is approximately proportional to the number of channels used. For example, the diameter of the orifices between 1 Torr and 0.1 Torr sections can typically be about 1 mm. Thus, in the case of the use of many channels, for the example of the 0.1 Torr region (outlets 1 and 2 in FIG. 4) may require to be pumped out by a roots blower/rotary vane pump similar to that used for pumping the 1 Torr section.

The gas load on the third vacuum region 24 and main vacuum region 28 (e.g., the 1 mTorr and 10⁻⁷ Torr regions) can be minimized by using quadrupoles instead of multipole ion guides with a smaller rod diameter to reduce the conductance limit between the high vacuum regions and, thus reducing the pumping load on the turbo pumps. The region of the pulser device and the reflectron (i.e. the 10⁻⁷ Torr region) may require an additional turbo pump to maintain the required vacuum.

Second-order focusing upon an initial spatial distribution of ions across the ion beam in the pulser device 30 permits, in one embodiment of the present invention, high (e.g., usually, more than 10,000) resolving power in the Qq-reTOF system. There are several approaches in the present invention to achieve second order space focusing. In one approach, for the oe-reTOF configuration, a single-stage extraction is used in conjunction with a two-stage ion mirror (reflectron). Alternatively, a two-stage extraction and a single-stage reflectron can be used. Both configurations permit adjusting two experimental parameters (i.e., the electric field strengths in two reflectron stages in the former approach and the extraction field and the reflecting field in the latter case) to zero the first and second expansion term in the dependence of the ion time-of-flight over the initial ion position in the pulser region.

In one embodiment of the present invention, the dependence of the total time-of-flight of an ion over the initial ion position in the pulser region is expanded into a series having the expansion terms of first, second, third, etc. orders over the deviation of the initial ion position from the ion beam axis. Then, by tuning the experimental parameters (usually by tuning the voltages as described above) the first and second expansion terms are zeroed, thus, achieving minimal dependence of the ion flight time on the initial ion position in the beam. Such techniques available to the present invention are referred to as a first (if the first term is zeroed only) or second order space focusing (if both the first and second terms are zeroed).

In principle, in the multi-channel schemes shown in the present invention, it is possible to obtain the second order space focusing simultaneously in all channels if all channels are substantially identical. This is because the geometry of time-of-flight section is the same for all channels. In practice, one can expect slight deviations from the ideal geometry due to manufacturing tolerances, accuracy of assembly and alignment. To tolerate small imperfections in the channel fabrication and accuracy of assembly, one embodiment of the present invention permits the control of at least one parameter separately for each channel.

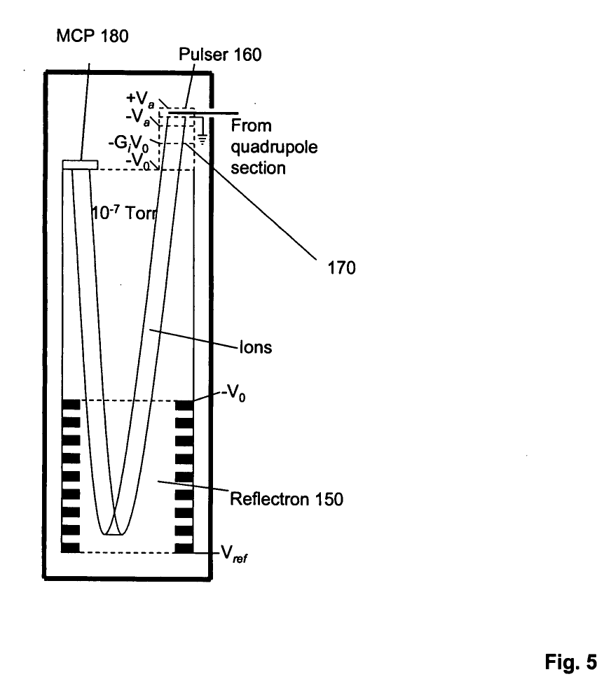

Since both tunable parameters in the single-stage extraction/double-stage reflectron approach are related to the reflectron which is shared between all channels, one embodiment of the present invention uses a double-stage extraction/single-stage reflectron scheme shown in FIG. 5 in which one tune parameter is located in the reflectron 150 and the other is in the pulser device 160. The same pulser and same extraction voltages +Vₐ, −Vₐ, −V₀, and reflectron voltage V_{ref} can be used in all channels. However, the −GᵢVₐ voltage (e.g., typically, Gᵢ=0.8-0.95) applied to a grid 170 separating the first and second extraction regions can be slightly different for different channels allowing minor adjustment of channel focusing due to imperfection of their fabrication and assembly.

One method for adjustment is based on experimentally observed relative insensitivity of the space focusing conditions on the tune parameters (−GᵢVₐ and V_{ref}). This is due to presence of other factors limiting the mass resolution in QqTOF-MS, among which is the so-called “turn-around” effect due to a small transverse velocity of ions in the beam entering the pulser region. The “turn-around-time” actually determines the final system resolution (after the second-order space focusing is achieved). For this reason, typically no channel-specific adjustment of the grid voltage −GᵢVₐ is required.

In one embodiment of the present invention, ions can be detected using microchannel plate (MCP) 180 (as shown in FIG. 5) with a single or multiple anodes. Ion detection can work in ion counting or ion current measurement modes. Mass accuracy in conventional high-performance QTOF instruments and in the present invention was significantly improved and reached few ppm mainly due to switching from time-to-digital converter (TDC) to analog-to-digital converter (ADC) in the signal acquisition (SA) system. With a typical TDC-based digitizer, it possible to record the arrival time of a single ion on the MCP detector with 0.1 ns time resolution and to reach resolution of 5 ns between the arrival of two ions (dead time). The dead time appears as the minimum time interval necessary for signal processing in both TDC and constant fraction discriminator (CFD) used for amplification and thresholding of nanosecond pulses from MCP.

If the time interval between the arrivals of two or more ions is shorter than the dead time, the peak shape obtained by summation of all ion hit events may be distorted and so mass accuracy may be compromised. The ADC systems (digitizers) do not have inherent dead time. Modern 8-bit ADC's with real-time on-board averaging have digitizing rate of several gigahertz (for example, a FASTFLIGHT Digital Signal Averager from Signal Recovery, Oak Ridge, Tenn.).

While described in detail above, the present invention can be considered more generally to include the following embodiments not limited to the specific features described above.

In one embodiment of the present invention, the parallel mass spectroscopy sampling of the present invention is directed to protemics applications which can benefit from the present techniques providing high mass accuracy and high throughput.

In one embodiment of the present invention, the parallel mass spectroscopy sampling of the present invention is provided for in a novel mass spectrometry system in which components of the system are shared in common between the multi-channels.

In one embodiment of the present invention, the parallel mass spectroscopy sampling of the present invention is provided for in a novel system including an orthogonal acceleration time-of-flight mass analyzer having at least two channels for ion introduction into the mass analyzer, a field-free section configured to mass-separate ions during flight time, and an ion detector for detection of ions transiting the field-free region. The two channels are configured to receive respective groups of ions in separate ones of the channels for mass analysis of the respective groups of ions. At least a part of the field-free section is shared between the two channels.

In one embodiment of the present invention, the parallel mass spectroscopy sampling of the present invention is provided for in a novel multi-channel oa-reTOF mass spectrometry system in which the reflectron is shared, as it typically represents one of the largest components in the oa-reTOF mass spectrometer. However, other components of the oa-reTOF mass spectrometer can be shared as well.

In one embodiment of the present invention, ions can be produced in at least two ion sources and thereafter can be directed to different channels of the multi-channel orthogonal extraction (oe) reflectron TOF (reTOF) mass spectrometer in which the two channels share for example a common reflectron in their operation.

In another embodiment of the present invention, the two channels can share an orthogonal accelerator of ions.

In another embodiment of the present invention, a common orthogonal accelerator can extract ions into the common reflectron with a frequency in the range from 10 Hz to 100 kHz.

In another embodiment of the present invention, the mass spectrometer can include a data system which acquires mass spectra corresponding to each of the two channels.

In another embodiment of the present invention, the data system can include at least one microchannel plate (MCP) ion detector which operates in an ion counting or mocke on ion current measurement mode.

In another embodiment of the present invention, the ions can be time-focused on the microchannel plate detector using at least one of a first order space focusing and a second order space focusing.

In another embodiment of the present invention, the microchannel plate detector can have multiple anodes, used for detecting ions directed to different channels.

In another embodiment of the present invention, the two channels can include atmospheric pressure (AP) interfaces and ion guides to deliver ions to the common accelerator and reflectron and the atmospheric pressure interfaces. The ion guides can share common DC and RF power supplies.

In another embodiment of the present invention, the mass spectrometer can be placed into a multi-section vacuum chamber with differentially-pumped sections and there sections can be shared between the two channels.

In another embodiment of the present invention, the mass spectrometer can include at least one of a single stage oe-reTOF mass analyzer, a double stage oe-reTOF mass analyzer, a multipass oe-reTOF mass analyzer, and a Hadamard oe-reTOF mass analyzer.

In another embodiment of the present invention, the mass spectrometer can include at least one of an ion isolation means and an ion fragmentation means.

In another embodiment of the present invention, the ion isolation device can include at least one of a quadrupole RF/DC mass filter, a broad-band excitation mass filter, a stored waveform isolation Fourier transform (SWIFT) isolation, and a notched broad-band excitation.

In another embodiment of the present invention, the ion fragmentation device can include at least one of a collision-induced dissociation, a surface-induced dissociation, an electron capture dissociation, an electron transfer dissociation, and a metastable atom-induced dissociation.

One feature of the present invention is the utilization of the pulser device to re-direct ions from for example a horizontal direction to a vertical direction, as shown in the figures. In one embodiment of the present invention, once the ions are re-directed, the ions are then mass analyzed to identify the constituents of those ions that originated from the respective ion sources. While a reflectron time-of-flight analyzer has been shown for the mass analyzer, the mass analyzer in one embodiment of the present invention could be a linear time-of-flight analyzer. In other embodiments of the present invention, the mass analyzer receiving ions from pulser could be a quadrupole ion trap (QIT), a toroidal ion trap, a linear quadrupole ion trap, an orbitrap, a Fourier transform mass spectrometer (FT-MS), an ion mobility spectrometer (IMS), a high-field asymmetric, waveform ion mobility spectrometer (FAIMS), and their combination(s).

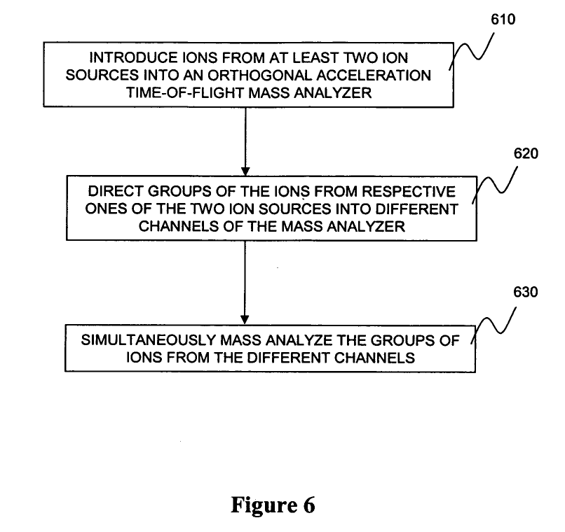

FIG. 6 is a flowchart illustrating a method according to one embodiment of the present invention for mass analysis of ions. At 610, ions are introduced from at least two sources of ions into an orthogonal acceleration time-of-flight mass analyzer (such as for example an orthogonal acceleration reflectron time of flight mass analyzer). At 620, groups of ions are directed from respective ones of the two sources to different channels of the mass analyzer. At 630, the groups of ions from the different channels are mass-analyzed simultaneously.

At step 610, the ion sources can be one of an electrospray ionization (ESI) source, an atmospheric pressure chemical ionization (APCI) source, an atmospheric pressure photo-ionization (APPI) source, a matrix-assisted laser desorption/ionization (MALDI) source, and a atmospheric pressure (AP) MALDI source. At 600,

At 620, the ions can be directed into a reflection shared by at least two ion introduction channels in the mass analyzer. At 620, the ions can be directed into an orthogonal accelerator is shared between the at least two channels. At 620,

At 630, a data acquisition system can acquire mass spectra corresponding to the group of ions introduced in the channels. At 630, the data acquisition system can operate an ion counting mode or an ion current measurement mode. At 630, mass spectra can be obtained from a tandem (MS/MS or MSn) mass selection. At 630, a quadrupole RF/DC mass filter, a broad-band excitation mass filter, a stored waveform isolation Fourier transform (SWIFT) isolation mass filter, and/or a notched broad-band excitation mass filter can be used for ion isolation in the mass analyzer. At 630, the ions can be fragments in a collision-induced dissociation unit, a surface-induced dissociation unit, an electron capture dissociation unit, an electron transfer dissociation unit, a fast atom bombardment dissociation unit, and a metastable atom-induced dissociation unit.

Numerous modifications and variations on the present invention are possible in light of the above teachings. It is, therefore, to be understood that within the scope of the accompanying claims, the invention may be practiced otherwise than as specifically described herein.

1. A mass spectrometer system comprising:
an orthogonal acceleration time-of-flight mass analyzer having,
at least two channels configured to receive respective groups of ions from respective ion sources, and
a field-free section configured to mass-separate ions during flight time;
said groups of ions being directed to different ones of the at least two channels of said mass analyzer for mass analysis of the respective groups of ions; and
at least a part of said field-free section shared between said at least two channels.

2. The system as in claim 1, further comprising a reflectron which is at least partly shared between said at least two channels.

3. The system as in claim 1, wherein the orthogonal acceleration time-of-flight mass analyzer comprises an orthogonal acceleration linear time-of-flight mass analyzer.

4. The system as in claim 1, further comprising an orthogonal accelerator.

5. The system as in claim 4, wherein the orthogonal accelerator is shared between the at least two channels.

6. The system as in claim 4, wherein the orthogonal accelerator has at least two stages of acceleration.

7. The system as in claim 6, wherein at least one of said at least two stages of acceleration comprises a stage tuned specifically for one of the at least of two channels.

8. The system as in claim 4, wherein the orthogonal accelerator is configured to extract ions into said reflectron with a frequency in the range from 10 Hz to 100 kHz.

9. The system as in claim 1, comprising:
at least two sources of ions.

10. The system as in claim 9, wherein the sources of ions comprise at least one of an electrospray ionization (ESI) source, an atmospheric pressure chemical ionization (APCI) source, an atmospheric pressure photo-ionization (APPI) source, a matrix-assisted laser desorption/ionization (MALDI) source, and an atmospheric pressure (AP) MALDI source.

11. The system as in claim 1, where said mass analyzer comprises:
a data acquisition system configured to acquire mass spectra corresponding to the at least two channels.

12. The system as in claim 11, where said data acquisition system includes at least one ion detector for at least one of said at least two channels.

13. The system as in claim 11, where said data acquisition system further comprises:
at least one microchannel plate (MCP) detector configured to operate in at least one of an ion counting mode and an ion current measurement mode.

14. The system as in claim 13, further comprising:
ion optics configured to time-focus ions on the MCP detector using at least one of first order space focusing and second order space focusing.

15. The system as in claim 13, wherein the MCP detector comprises multiple anodes.

16. The system as in claim 15, wherein the multiple anodes are configured to detect ions directed to different ones of the at least two channels.

17. The system as in claim 1, further comprising:
an atmospheric pressure interface for introduction of atmospheric ions into at least one of said at least two channels.

18. The system as in claim 17, wherein the atmospheric pressure interface comprises at least one of a capillary input, a heated capillary input, an orifice, a skimmer, a quadrupole ion guide, a multipole ion guide, an ion mobility separator, and an electrostatic ion guide.

19. The system as in claim 18, wherein the atmospheric pressure interface is operated using at least one of a DC voltage power supply and an RF voltage power supply which is shared between the at least two channels.

20. The system as in claim 1, further comprising a vacuum chamber having multiple differentially pumped sections.

21. The system as in claim 20, wherein at least some of the multiple differentially pumped sections are shared between the at least two channels.

22. The system as in claim 20, wherein at least one of the multiple differentially pumped sections is pumped by a pump separated from another one of the multiple differentially pumped sections.

23. The system as in claim 1, wherein the mass analyzer comprises at least one of a single stage orthogonal acceleration reflectron (re) TOF mass analyzer, a double stage oa-reTOF mass analyzer, a multipass oa-reTOF mass analyzer, and a Hadamard oa-reTOF mass analyzer.

24. The system as in claim 23, wherein at least part of the reflectron is shared between the at least two channels.

25. The system as in claim 1, where the mass analyzer comprises at least one of an ion isolation device and an ion fragmentation device

26. The system as in claim 25, wherein the ion isolation device and the ion fragmentation device are configured to fragment ions to obtain a tandem (MS/MS or MSn) mass spectrum.

27. The system as in claim 25, wherein the ion isolation device comprises at least one of a quadrupole RF/DC mass filter, a broad-band excitation mass filter, a stored waveform isolation Fourier transform (SWIFT) isolation mass filter, and a notched broad-band excitation mass filter.

28. The system as in claim 25, wherein said ion fragmentation device comprises at least one of a collision-induced dissociation unit, a surface-induced dissociation unit, an electron capture dissociation unit, an electron transfer dissociation unit, a fast atom bombardment dissociation unit, and a metastable atom-induced dissociation unit.

29. A method for mass analysis of ions, comprising:
introducing the ions from at least two sources of ions into an orthogonal acceleration time-of-flight mass analyzer;
directing groups of ions from respective ones of the two sources into different channels of the mass analyzer;
simultaneous mass-analyzing of the groups of ions from the different channels.

30. A system for mass analysis of ions, comprising:
means for introducing the ions from at least two sources of ions into an orthogonal acceleration time-of-flight mass analyzer having at least two channels;
means for directing groups of ions from respective ones of the two sources into different channels of the mass analyzer;
means for simultaneous mass-analyzing of the groups of ions from the different channels.

31. A mass spectrometer system comprising:
an orthogonal acceleration time-of-flight mass analyzer having,
at least two channels configured to receive respective groups of ions from respective ion sources, and
a reflectron;
said groups of ions being directed to different ones of the at least two channels of said mass analyzer for mass analysis of the respective groups of ions; and
at least a part of said reflectron shared between said at least two channels.
